(19) United States
(12) Patent Application Publication
(10) Pub. No.: US 2024/0345519 A1
(43) Pub. Date: Oct. 17, 2024

(54) IMAGE FORMING APPARATUS

(71) Applicant: KYOCERA Document Solutions Inc., Osaka (JP)

(72) Inventor: Sadanori NAKAE, Osaka (JP)

(73) Assignee: KYOCERA Document Solutions Inc., Osaka (JP)

(21) Appl. No.: 18/626,724

(22) Filed: Apr. 4, 2024

(30) Foreign Application Priority Data
Apr. 12, 2023 (JP) 2023-064756

(51) Int. Cl. G03G 15/00; G03G 15/01; G03G 15/16; G03G 21/00

(52) U.S. Cl. CPC G03G 15/5004; G03G 15/0126; G03G 15/0131; G03G 15/0189; G03G 15/161; G03G 15/5008; G03G 15/80; G03G 21/0058; G03G 21/007

(57) ABSTRACT

An image forming apparatus performs a transfer residual toner collection operation including a toner adhesion step of allowing transfer residual toner to temporarily adhere to the collecting roller during execution of image forming operation, a toner moving step of moving the transfer residual toner adhered on the collecting roller to an image carrier after the image forming operation is finished, and a toner collecting step of moving the transfer residual toner from the image carrier to an intermediate transfer body so that a cleaning mechanism can collect the transfer residual toner. The control unit controls an image forming unit having developing current less than a threshold value, to apply the collecting roller with a voltage having the same polarity as toner charge polarity in the toner adhesion step, and to apply the collecting roller with a voltage having opposite polarity to the toner charge polarity in the toner moving step.

### INCORPORATION BY REFERENCE

This application is based upon and claims the benefit of priority from the corresponding Japanese Patent Application No. 2023-064756 filed Apr. 12, 2023, the entire contents of which are hereby incorporated by reference.

### BACKGROUND

The present disclosure relates to an electrophotographic image forming apparatus, and particularly to an intermediate transfer type image forming apparatus, in which individual color toner images formed on image carriers are primarily transferred onto an intermediate transfer body, and then are secondarily transferred onto a recording medium.

Conventionally, there is known an intermediate transfer type image forming apparatus including an endless intermediate transfer belt that is rotated in a predetermined direction, and a plurality of image forming units disposed along the intermediate transfer belt, in which the image forming units sequentially overlay individual color toner images onto the intermediate transfer belt in primary transfer, and then a secondary transfer roller (transfer member) transfers the toner images onto a recording medium such as a paper sheet in secondary transfer.

In this image forming apparatus, after the primary transfer, a part of the toner image (transfer residual toner) remains on a photosensitive drum (image carrier) disposed in each of the image forming units. Therefore, it is necessary to remove the transfer residual toner on the photosensitive drum in preparation for next image forming operation.

### SUMMARY

An image forming apparatus according to one aspect of the present disclosure includes a plurality of image forming units, an intermediate transfer body, a primary transfer member, a secondary transfer member, a collecting roller, a cleaning mechanism, a developing voltage power supply, a charging voltage power supply, a transfer voltage power supply, a cleaning voltage power supply, and a control unit. The plurality of image forming units each include an image carrier having a photosensitive layer on a surface thereof, a charging device that charges the image carrier, an exposing device that exposes the image carrier charged by the charging device so as to form an electrostatic latent image, and a developing device having a developer carrier that carries developer containing toner, the developing device allowing the toner to adhere to the electrostatic latent image formed on the image carrier, so as to form a toner image. The intermediate transfer body is capable of moving along the plurality of image forming units, so that the toner image formed by the image forming unit is primarily transferred onto the intermediate transfer body. The primary transfer member primarily transfers the toner image formed on the image carrier onto the intermediate transfer body. The secondary transfer member secondarily transfers onto a recording medium the toner image transferred onto the intermediate transfer body. The collecting roller is disposed in each of the plurality of image forming units, so as to collect transfer residual toner remaining on the image carrier after the primary transfer. The cleaning mechanism removes the toner adhered to the intermediate transfer body. The developing voltage power supply applies a developing voltage to the developer carrier. The charging voltage power supply applies a charging voltage to the charging device. The transfer voltage power supply applies transfer voltages to the primary transfer member and the secondary transfer member. The cleaning voltage power supply applies a voltage to the collecting roller. The control unit controls the image forming unit, the developing voltage power supply, the transfer voltage power supply, the charging voltage power supply, and the cleaning voltage power supply. The image forming apparatus performs a transfer residual toner collection operation including a toner adhesion step of applying a voltage having opposite polarity to charge polarity of the toner to the collecting roller during execution of an image forming operation, so as to allow the transfer residual toner to temporarily adhere to the collecting roller, a toner moving step of separating the developer carrier and the image carrier from each other after finishing the image forming operation, and then applying a voltage having the same polarity as the charge polarity of the toner to the collecting roller, so as to move the transfer residual toner adhered on the collecting roller to the image carrier, and a toner collecting step of moving the transfer residual toner from the image carrier to the intermediate transfer body, so that the cleaning mechanism collects the transfer residual toner. The image forming apparatus further includes a current detection unit that detects developing current flowing between the image carrier and the developer carrier. The control unit controls the image forming unit having the developing current less than a threshold value, to apply the voltage having the same polarity as the charge polarity of the toner to the collecting roller in the toner adhesion step, and to apply the voltage having opposite polarity to the charge polarity of the toner to the collecting roller in the toner moving step, so as to perform the transfer residual toner collection operation.

### BRIEF DESCRIPTION OF THE DRAWINGS

FIG. 1 is a cross-sectional side view illustrating an internal structure of an image forming apparatus according to an embodiment of the present disclosure.

FIG. 2 is a partial enlarged view of an image forming unit and its vicinity, including control paths of the image forming apparatus.

FIG. 3 is a graph indicating a relationship between absolute humidity and toner charge amount.

FIG. 4 is a graph indicating a relationship between the toner charge amount and reversely transferred toner amount.

FIG. 5 is a flowchart illustrating a control example of a transfer residual toner collection operation in the image forming apparatus of the present disclosure.

### DETAILED DESCRIPTION

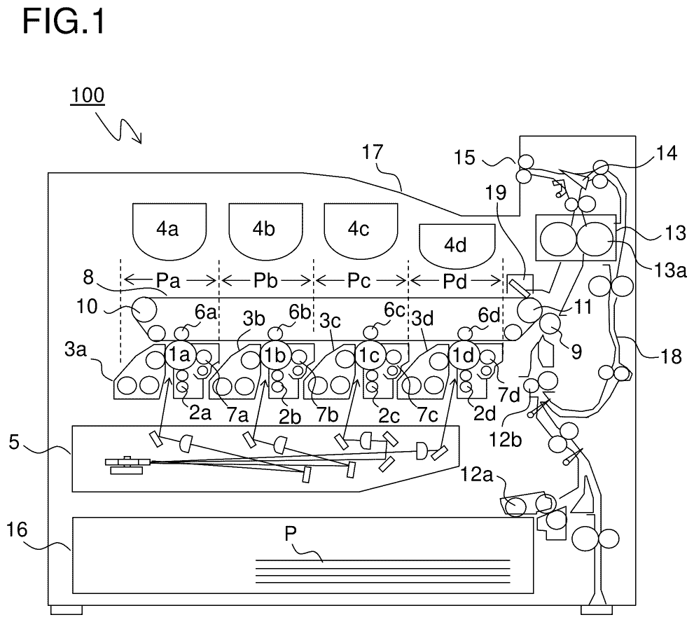

Hereinafter, an embodiment of the present disclosure is described with reference to the drawings. FIG. 1 is a cross-sectional side view illustrating an internal structure of an image forming apparatus 100 according to an embodiment of the present disclosure. In a main body of the image forming apparatus 100 (e.g. a color printer), there are four image forming units Pa, Pb, Pc, and Pd disposed in order from an upstream side in a conveying direction (from the left side in FIG. 1). These image forming units Pa to Pd are disposed corresponding to four images of different colors (yellow, magenta, cyan, and black colors), and the yellow, cyan, magenta, and black images are sequentially formed each by charging, exposing, developing, and transferring steps.

These image forming units Pa to Pd are provided with photosensitive drums (image carriers) 1a, 1b, 1c, and 1d, respectively, each of which carries a visual image (toner image) of each color. Further, an intermediate transfer belt 8, which is rotated in a counter-clockwise direction in FIG. 1 by a belt drive motor (not shown), is disposed adjacent to the image forming units Pa to Pd. The toner images formed on the photosensitive drums 1a to 1d are sequentially and primarily transferred and overlaid onto the intermediate transfer belt 8, which moves while contacting with the photosensitive drums 1a to 1d. After that, the toner images primarily transferred onto the intermediate transfer belt 8 are secondarily transferred by a secondary transfer roller 9 onto a paper sheet P as an example of a recording medium. Further, the paper sheet P with the toner images secondarily transferred passes a fixing unit 13 in which the toner images are fixed, and then is discharged from the main body of the image forming apparatus 100. The photosensitive drums 1a to 1d are rotated in a clockwise direction in FIG. 1, while an image forming process is performed in each of the photosensitive drums 1a to 1d.

The paper sheet P onto which the toner image is secondarily transferred is stored in a paper sheet cassette 16 disposed in a lower part of the main body of the image forming apparatus 100, and is conveyed by a sheet feed roller 12a and a registration roller pair 12b to a nip part between the secondary transfer roller 9 and a drive roller 11 of the intermediate transfer belt 8. A dielectric resin sheet is used for the intermediate transfer belt 8, and a seamless belt is mainly used for it. In addition, on a downstream side of the secondary transfer roller 9, there is disposed a belt cleaning device 19 for removing toner and the like remaining on a surface of the intermediate transfer belt 8.

Next, the image forming units Pa to Pd are described. Around and below the photosensitive drums 1a to 1d disposed in a rotatable manner, there are disposed charging devices 2a, 2b, 2c, and 2d that charge the photosensitive drums 1a to 1d, respectively, an exposing device 5 that exposes the photosensitive drums 1a to 1d corresponding to image information, developing devices 3a, 3b, 3c, and 3d that form toner images on the photosensitive drums 1a to 1d, respectively, and cleaning devices 7a, 7b, 7c, and 7d that remove toner (transfer residual toner) and the like remaining on the photosensitive drums 1a to 1d, respectively.

When image data is input from a host device such as a personal computer, the charging devices 2a to 2d first uniformly charge the surfaces of the photosensitive drums 1a to 1d, respectively. Next, the exposing device 5 emits light corresponding to the image data so as to form electrostatic latent images corresponding to the image data on the photosensitive drums 1a to 1d, respectively. The developing devices 3a to 3d are filled with predetermined amounts of two-component developer containing toner of yellow, magenta, cyan, and black colors, respectively. Note that when a ratio of the toner in the two-component developer filled in the developing device 3a to 3d is decreased below a specified value due to toner image formation described later, the toner is replenished to the developing device 3a to 3d from a toner container 4a to 4d. The toner in the developer is supplied to the photosensitive drum 1a to 1d from the developing device 3a to 3d and electrostatically adheres to the same, so as to form the toner image corresponding to the electrostatic latent image formed by exposure from the exposing device 5.

Further, a primary transfer roller 6a to 6d applies an electric field of a predetermined transfer voltage between the primary transfer roller 6a to 6d and the photosensitive drum 1a to 1d, and hence the toner images of yellow, magenta, cyan, and black colors on the photosensitive drums 1a to 1d are primarily transferred onto the intermediate transfer belt 8. These four color images are formed with a predetermined positional relationship for forming a predetermined full color image. After that, in preparation for following formation of a new electrostatic latent image, the cleaning devices 7a to 7d remove the toner and the like remaining on the surfaces of the photosensitive drums 1a to 1d after the primary transfer.

The intermediate transfer belt 8 is wrapped around a driven roller 10 on the upstream side and the drive roller 11 on the downstream side. When the drive roller 11 is rotated by the belt drive motor (not shown), the intermediate transfer belt 8 starts to rotate in the counter-clockwise direction, and the paper sheet P is conveyed from the registration roller pair 12b at a predetermined timing, to the nip part (secondary transfer nip part) between the drive roller 11 and the secondary transfer roller 9 disposed adjacent thereto, so that the toner images on the intermediate transfer belt 8 are secondarily transferred onto the paper sheet P. The toner and the like remaining on the surface of the intermediate transfer belt 8 after the secondary transfer are removed by the belt cleaner 19. The paper sheet P with the toner images secondarily transferred is conveyed to the fixing unit 13.

The paper sheet P conveyed to the fixing unit 13 is heated and pressed by a fixing roller pair 13a, and the toner images are fixed to the surface of the paper sheet P, so that a predetermined full color image is formed. A conveying direction of the paper sheet P with the full color image formed is selected by a branch part 14 that branches in a plurality of directions, and the paper sheet P is discharged by a discharge roller pair 15 onto a discharge tray 17 as it is (or after being sent to a double-side conveying path 18 and after image formation on both sides).

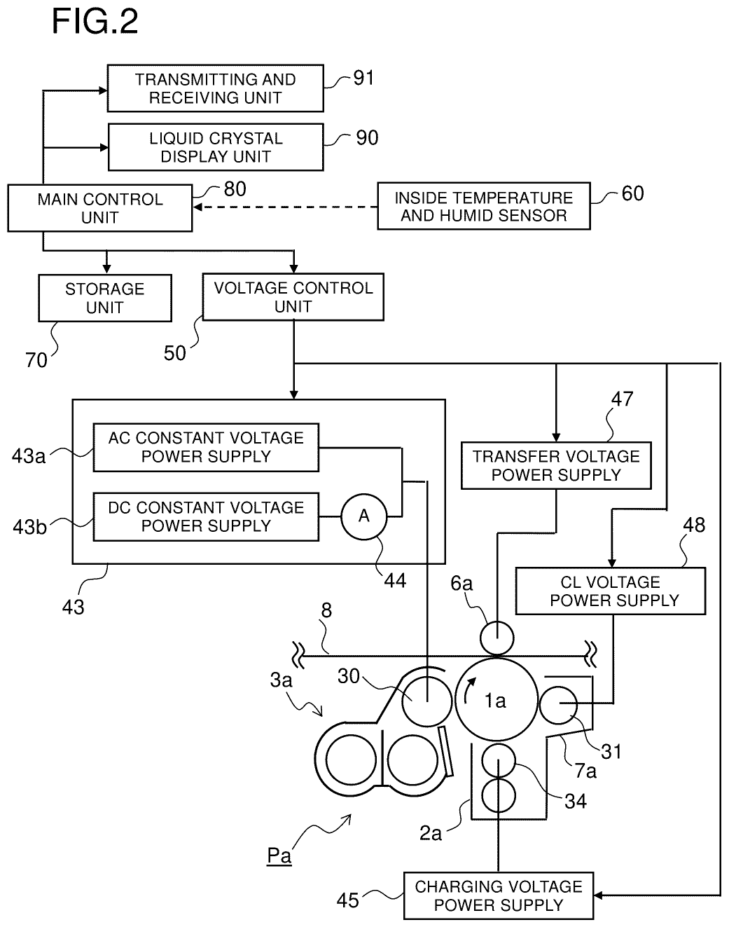

FIG. 2 is a partial enlarged view of the image forming unit Pa and its vicinity, including control paths of the image forming apparatus 100. In the following description, a structure and control paths of the image forming unit Pa are described. The image forming units Pb to Pd have the same structure and control paths as those of the image forming unit Pa, and hence descriptions thereof are omitted.

The developing device 3a includes a developing roller 30 that carries the two-component developer in the developing device 3a. The developing roller 30 is connected to a developing voltage power supply 43 that produces an oscillating voltage in which a DC voltage and an AC voltage are superimposed. The developing voltage power supply 43 includes an AC constant voltage power supply 43a and a DC constant voltage power supply 43b. The AC constant voltage power supply 43a outputs a sine wave AC voltage generated from a pulse-modulated low DC voltage using a step up transformer (not shown). The DC constant voltage power supply 43b outputs a DC voltage obtained by rectifying the sine wave AC voltage generated from a pulse-modulated low DC voltage using the step up transformer.

In image formation, the developing voltage power supply 43 outputs the developing voltage, in which the AC voltage from the AC constant voltage power supply 43a is superimposed on the DC voltage from the DC constant voltage power supply 43b. A current detection unit 44 detects developing current flowing between the photosensitive drum 1a and the developing roller 30.

A charging voltage power supply 45 applies a charging roller 34 of the charging device 2a with a charging voltage in which an AC voltage is superimposed on a DC voltage. The charging voltage power supply 45 has the same structure as that of the developing voltage power supply 43.

A transfer voltage power supply 47 applies the primary transfer rollers 6a to 6d and the secondary transfer roller 9 (see FIG. 1) with a primary transfer voltage and a secondary transfer voltage, respectively, which have the opposite polarity to the toner (a negative polarity). In this embodiment, a constant current control is performed, in which the primary transfer rollers 6a to 6d and the secondary transfer roller 9 are applied with the transfer voltages, which supply the primary transfer rollers 6a to 6d and the secondary transfer roller 9 with constant current (transfer current) having the opposite polarity to the toner (a negative polarity).

The cleaning device 7a includes a collecting roller 31 that temporarily holds the transfer residual toner on the surface of the photosensitive drum 1a. The collecting roller 31 is connected to a cleaning voltage power supply 48 that produces a DC voltage. The cleaning voltage power supply 48 applies the collecting roller 31 with a voltage having the same polarity as the toner (a positive polarity) and a voltage having the opposite polarity to the same (negative polarity). The cleaning voltage power supply 48 has the same structure as the DC constant voltage power supply 43b.

Next, a control system of the image forming apparatus 100 is described with reference to FIG. 2. The image forming apparatus 100 is provided with a main control unit 80 constituted of a CPU and the like. The main control unit 80 is connected to a storage unit 70 constituted of a ROM, a RAM, and the like. On the basis of a control program and data for control stored in the storage unit 70, the main control unit 80 controls individual units of the image forming apparatus 100 (the charging devices 2a to 2d, the developing devices 3a to 3d, the exposing device 5, the primary transfer rollers 6a to 6d, the cleaning devices 7a to 7d, the secondary transfer roller 9, the fixing unit 13, the developing voltage power supply 43, the charging voltage power supply 45, the transfer voltage power supply 47, the cleaning voltage power supply 48, a voltage control unit 50, and the like).

On the basis of control signals sent from the main control unit 80, the voltage control unit 50 controls the developing voltage power supply 43 that applies the developing voltage to the developing roller 30, the charging voltage power supply 45 that applies the charging voltage to the charging roller 34, the transfer voltage power supply 47 that applies the transfer voltages to the primary transfer rollers 6a to 6d and the secondary transfer roller 9, and the cleaning voltage power supply 48 that applies the voltage to the collecting roller 31. Note that the voltage control unit 50 may be constituted of the control program stored in the storage unit 70.

An inside temperature and humid sensor 60 always detects temperature and relative humid inside the image forming apparatus 100, specifically near the image forming units Pa to Pd. Detected temperature and humid are sent to the main control unit 80.

The main control unit 80 is connected to a liquid crystal display unit 90 and a transmitting and receiving unit 91. The liquid crystal display unit 90 functions as a touch panel for a user to make various settings of the image forming apparatus 100, and displays states of the image forming apparatus 100, an image forming status, the number of printed sheets, and the like. The transmitting and receiving unit 91 performs external communication using a telephone line or the Internet line. The transmitting and receiving unit 91 functions as an input unit that receives a print command and image data from a host device such as a personal computer.

Next described is a collection operation of the transfer residual toner in the image forming apparatus 100 of this embodiment. When printing operation is started, the toner image formed on the photosensitive drum 1a to 1d is primarily transferred onto the intermediate transfer belt 8 by the primary transfer roller 6a to 6d. Then, the collecting roller 31 of the cleaning device 7a to 7d, which is disposed on the downstream side of the primary transfer roller 6a to 6d in the rotation direction of the photosensitive drum 1a to 1d, is applied with a voltage having the opposite polarity (negative polarity) to a positive polarity that is a normal charge polarity of the toner (hereinafter simply referred to as a toner charge polarity). In this way, the transfer residual toner on the photosensitive drum 1a to 1d is allowed to temporarily adhere to the collecting roller 31 (a toner adhesion step).

After that, at timing such as between paper sheets in continuous printing or after printing operation, the developing roller 30 is separated from the photosensitive drum 1a to 1d. In this state, the collecting roller 31 is applied with a voltage having the same polarity (positive polarity) as the toner charge polarity (positive polarity). In this way, the transfer residual toner held by the collecting roller 31 is moved to the photosensitive drum 1a to 1d (a toner moving step). The transfer residual toner after moving to the photosensitive drum 1a to 1d is transferred onto the intermediate transfer belt 8 by the primary transfer roller 6a to 6d, and is removed and collected by the belt cleaning device 19 (a toner collecting step).

In the intermediate transfer type image forming apparatus 100, when a toner charge amount is decreased, a ratio of reversely charged toner is increased, which is charged to the opposite polarity (negative polarity) to the toner charge polarity (positive polarity) after the primary transfer. If the ratio of the reversely charged toner on the intermediate transfer belt 8 is increased, reverse transfer may occur as follows. For instance, when the toner image primarily transferred by the image forming unit Pa passes the image forming unit Pb to Pd on the downstream side, the toner adheres to the photosensitive drum 1b to 1d of the image forming unit Pb to Pd.

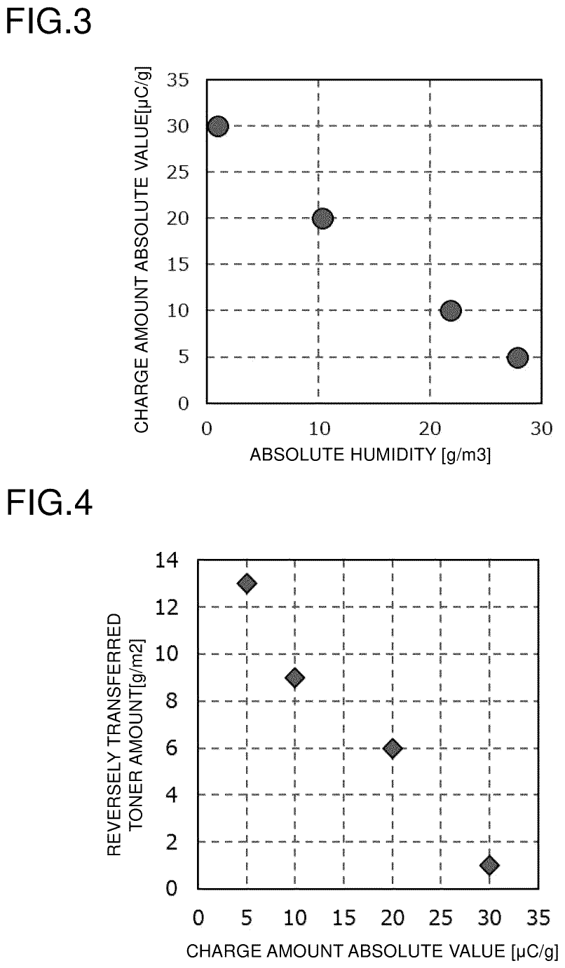

FIG. 3 is a graph indicating a relationship between absolute humidity and the toner charge amount. FIG. 4 is a graph indicating a relationship between the toner charge amount and reversely transferred toner amount. As illustrated in FIG. 3, when the absolute humidity (absolute water content) is increased, an absolute value of the toner charge amount is decreased. In addition, as illustrated in FIG. 4, when the absolute value of the toner charge amount is decreased, the reversely transferred toner amount is increased.

At this time, if the toner adheres to a white background (non-image part) of the photosensitive drum 1b to 1d, background fogging may occur. In addition, the reversely transferred toner has the same polarity (negative polarity) as the cleaning voltage applied to the collecting roller 31, and hence it is not collected by the collecting roller 31, but after passing the charging devices 2a to 2d, it has the normal polarity (positive polarity) again and is collected by the developing roller 30. Thus, mixture of colors may occur.

Therefore, in the image forming apparatus 100 of this embodiment, if decrease in the toner charge amount is predicted, a transfer residual toner collection operation is performed, in which the voltage having the same polarity as the toner charge polarity is applied when the toner is allowed to temporarily adhere to the collecting roller 31, and the voltage having the opposite polarity to the toner charge polarity is applied when the toner is moved again to the photosensitive drum 1a to 1d. Hereinafter, there are described a method of predicting decrease in the toner charge amount, and an execution procedure of the transfer residual toner collection operation based on the method, as a characterized part of the present disclosure.

### (Method of Predicting Decrease in Toner Charge Amount)

If the developing current flowing in the developing roller 30 is high, the toner charge amount is high, while if it is low, the toner charge amount is low. Therefore, the developing current when a reference image (patch image) is developed under a preset developing condition (developing voltage) is detected by the current detection unit 44, and if the detected developing current is less than a threshold value, it can be predicted that the toner charge amount is decreased.

Examples of timing for predicting the toner charge amount include before starting a print job, such as when the image forming apparatus 100 is powered on (when the power thereof is turned on) or when returning from a sleep mode (power saving mode).

### (Transfer Residual Toner Collection Operation)

In the transfer residual toner collection operation of the image forming apparatus 100 of this embodiment, a threshold value of the developing current is set. In the image forming unit Pa to Pd having the developing current that is the threshold value or more, when the transfer residual toner is temporarily collected by the collecting roller 31, the voltage having the opposite polarity (negative polarity) to the toner charge polarity is applied to the collecting roller 31, and when the transfer residual toner is moved to the photosensitive drum 1a to 1d again, the voltage having the same polarity (positive polarity) as the toner charge polarity is applied to the collecting roller 31.

On the other hand, in the image forming unit Pa to Pd having the developing current less than the threshold value, when the transfer residual toner is temporarily collected by the collecting roller 31, the voltage having the same polarity (positive polarity) as the toner charge polarity is applied to the collecting roller 31, and when the transfer residual toner is moved to the photosensitive drum 1a to 1d again, the voltage having the opposite polarity (negative polarity) to the toner charge polarity is applied to the collecting roller 31.

The threshold value of the developing current may be one value, or two or more threshold values may be set. If two or more threshold values are set, the voltage that is applied to the collecting roller 31 is changed in accordance with the threshold value. In this way, the voltage corresponding to the toner charge amount can be applied to the collecting roller 31, and it is possible to efficiently perform adhesion of the transfer residual toner to the collecting roller 31 and movement of the transfer residual toner from the collecting roller 31 to the photosensitive drum 1a to 1d.

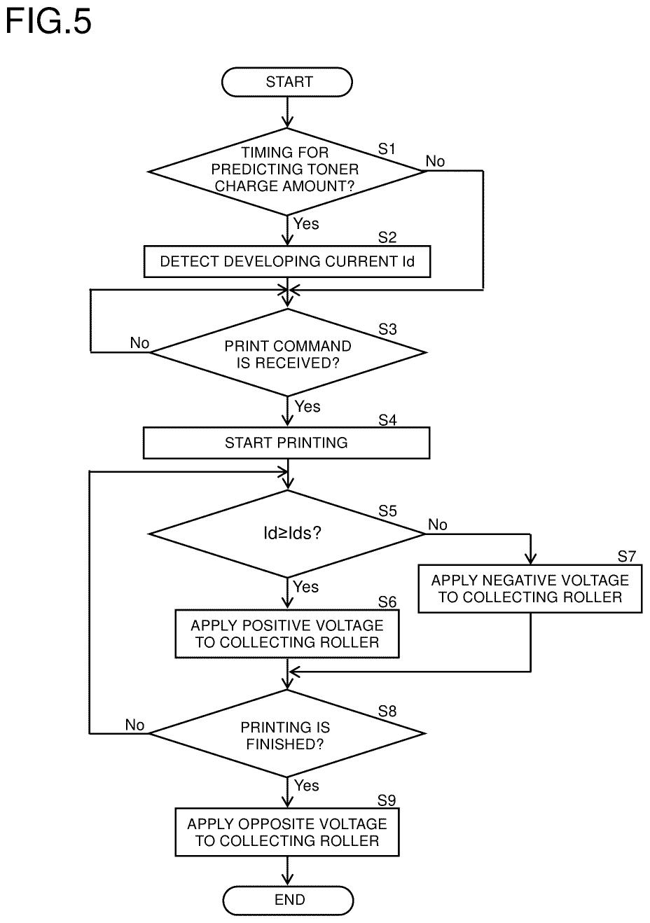

FIG. 5 is a flowchart illustrating a control example of the transfer residual toner collection operation in the image forming apparatus 100 of the present disclosure. With reference to FIGS. 1 to 4 as necessary, the execution procedure of the transfer residual toner collection operation is described with reference to the steps in FIG. 5.

First, the main control unit 80 determines whether or not it is timing for predicting the toner charge amount (Step S1). If it is the timing for predicting the toner charge amount such as when the image forming apparatus 100 is powered on or when returning from the sleep mode (Yes in Step S1), the reference image (patch image) is formed on the intermediate transfer belt 8, and developing current Id is detected (Step S2). The detected developing current Id is stored in the storage unit 70. If it is not the timing for predicting the toner charge amount (No in Step S1), the developing current Id that was detected and stored in the storage unit 70 at just previous timing for predicting the toner charge amount is used to perform the following steps.

Next, the main control unit 80 determines whether or not the print command is received (Step S3). If the print command is not received (No in Step S3), a print standby state is continued. If the print command is received (Yes in Step S3), printing is started (Step S4).

Next, the main control unit 80 determines whether or not the developing current Id is a predetermined threshold value Tds or more (Step S5). If Id≥Ids holds (Yes in Step S5), it is estimated that the toner charge amount is not decreased, and hence the negative voltage having the opposite polarity to the toner charge polarity is applied to the collecting roller 31 during printing (Step S6). If Id<Ids holds (No in Step S5), it is estimated that the toner charge amount is decreased, and hence the positive voltage having the same polarity as the toner charge polarity is applied to the collecting roller 31 during printing (Step S7).

After that, the main control unit 80 determines whether or not the printing is finished (Step S8). If the printing is continued (No in Step S8), the process returns to Step S5, and the application of the voltage to the collecting roller 31 (the toner adhesion step) is continued while the printing operation is continued (Steps S5 to S7).

On the other hand, if the printing is finished (Yes in Step S8), a voltage opposite to the voltage applied in Step S6 or S7 is applied to the collecting roller 31 in a state where the developing roller 30 is separated from the photosensitive drum 1a to 1d, so that the toner adhered to the collecting roller 31 is moved to the photosensitive drum 1a to 1d (Step S9, the toner moving step). After that, the toner is moved from the photosensitive drum 1a to 1d to the intermediate transfer belt 8, and is collected by the belt cleaner 19 (the toner collecting step), so as to finish the transfer residual toner collection operation.

According to the control example illustrated in FIG. 5, even if the toner charge amount changes due to a change in the absolute humidity or the like, the transfer residual toner can appropriately adhere to the collecting roller 31, and after moving the transfer residual toner adhered on the collecting roller 31 to the intermediate transfer belt 8 via the photosensitive drum 1a to 1d, the transfer residual toner can be appropriately removed using the belt cleaner 19. Therefore, it is possible to effectively suppress background fogging or mixture of colors in the image forming unit on the downstream side in the moving direction of the intermediate transfer belt 8, which is caused by the transfer residual toner in the image forming unit on the upstream side.

### (Other Preferred Structure)

If the developing current is less than the threshold value (if the toner charge amount is decreased), it is preferred, before first printing operation after the transfer residual toner collection operation is performed, in a state where the photosensitive drum 1a to 1d and the developing roller 30 are separated from each other, to apply the collecting roller 31 with the voltage having the same polarity as the toner charge polarity that was applied when the transfer residual toner was moved again to the photosensitive drum 1a to 1d in the just previous transfer residual toner collection operation.

In this way, the transfer residual toner held on the collecting roller 31 can be completely removed (reset), and there is no possibility that the transfer residual toner remaining on the collecting roller 31 would move to the photosensitive drum 1a to 1d, when a printing operation is started and polarity of the voltage applied to the collecting roller 31 is switched. In addition, it may be possible to alternately apply a positive polarity voltage and a negative polarity voltage to the collecting roller 31. In this way, both positively charged toner and reversely charged toner remaining on the collecting roller 31 can be removed.

Note that if the developing current is the threshold value or more (if the toner charge amount is not decreased), sufficient toner is discharged from the collecting roller 31 to the photosensitive drum 1a to 1d in the toner moving step after printing is finished. Therefore, it is not necessary to perform the reset operation described above before the first printing operation.

In addition, if the developing current is less than the threshold value, it is preferred to increase operating time of the collecting roller 31 and the photosensitive drum 1a to 1d (execution time of the toner moving step), when the toner that is temporarily collected from the photosensitive drum 1a to 1d to the collecting roller 31 is moved to the photosensitive drum 1a to 1d again, to be longer than that when the developing current is the threshold value or more. In addition, if the developing current is less than the threshold value, it is preferred to decrease rotation speed of the photosensitive drum 1a to 1d, when the transfer residual toner that is temporarily adhered to the collecting roller 31 is moved to the photosensitive drum 1a to 1d again, to be slower than that when the developing current is the threshold value or more.

In this way, the toner with decreased charge amount, which is hardly moved by an electric field, can be effectively and securely moved again from the collecting roller 31 to the photosensitive drum 1a to 1d.

Further, if the developing current is less than the threshold value, it is preferred to increase the charging voltage that is applied to the charging roller 34 during movement of the transfer residual toner from the collecting roller 31 to the photosensitive drum 1a to 1d, to be higher than that when the developing current is the threshold value or more.

In this way, the electric field between the collecting roller 31 and the photosensitive drum 1a to 1d during the toner moving step is increased, and hence the toner with decreased charge amount, which is hardly moved by an electric field, can be effectively and securely moved again from the collecting roller 31 to the photosensitive drum 1a to 1d.

In addition, if there is the image forming unit Pa to Pd having the developing current less than the threshold value, the voltage having the same polarity as the toner charge polarity is applied to the collecting roller 31 in the toner adhesion step, and in the toner moving step, the voltage having the opposite polarity to the toner charge polarity is applied to the collecting roller 31 of the image forming unit having the developing current less than the threshold value (e.g., the image forming unit Pa), and to the collecting roller 31 of the image forming unit disposed next to the above image forming unit on the downstream side in the conveying direction of the intermediate transfer belt 8 (the image forming unit Pb).

In this way, in both the image forming unit having a low toner charge amount and the image forming unit next thereto on the downstream side, background fogging or mixture of colors can be effectively suppressed.

Other than that, the present disclosure is not limited to the embodiment described above, but can be variously modified within the scope of the present disclosure without deviating from the spirit thereof. For instance, the present disclosure is not limited to the developing device equipped with the developing roller 30 illustrated in FIG. 2, but can be applied to any image forming apparatus 100 equipped with various types of the developing device using two-component developer containing toner and carrier. For instance, the present disclosure can also be applied in exactly the same manner to a developing method, in which the developing device 3a to 3d includes a magnetic roller (toner supply roller) that carries developer on its outer circumference surface, and only toner in the developer carried on the magnetic roller is supplied to the developing roller 30, so that a toner layer is formed on an outer circumference surface of the developing roller 30, and that an electrostatic latent image on the photosensitive drum 1a to 1d is developed. In addition, it can also be applied to a magnetic one-component developing type image forming apparatus 100 that uses magnetic one-component developer containing only magnetic toner.

In addition, in the embodiment described above, the color printer illustrated in FIG. 1 is exemplified as the image forming apparatus 100, but without limiting to the color printer, it may be other intermediate transfer type image forming apparatus such as a color copier, a digital multifunction peripheral, or a facsimile machine.

The present disclosure can be applied to an intermediate transfer type image forming apparatus, in which individual color toner images formed on image carriers are primarily transferred onto an intermediate transfer body, and then are secondarily transferred onto a recording medium. Using the present disclosure, it is possible to provide an image forming apparatus that can appropriately collect transfer residual toner by a collecting roller, even if it has low charge amount or opposite polarity.

What is claimed is:

1. An image forming apparatus comprising:
a plurality of image forming units each including
an image carrier having a photosensitive layer on a surface thereof,
a charging device that charges the image carrier,
an exposing device that exposes the image carrier charged by the charging device so as to form an electrostatic latent image, and
a developing device having a developer carrier that carries developer containing toner, the developing device allowing the toner to adhere to the electrostatic latent image formed on the image carrier, so as to form a toner image;
an intermediate transfer body that is capable of moving along the plurality of image forming units, so that the toner image formed by the image forming unit is primarily transferred onto the intermediate transfer body;
a primary transfer member that primarily transfers the toner image formed on the image carrier onto the intermediate transfer body;
a secondary transfer member that secondarily transfers onto a recording medium the toner image transferred onto the intermediate transfer body;
a cleaning mechanism that removes the toner adhered to the intermediate transfer body;
a developing voltage power supply that applies a developing voltage to the developer carrier;
a charging voltage power supply that applies a charging voltage to the charging device;
a transfer voltage power supply that applies transfer voltages to the primary transfer member and the secondary transfer member;
a collecting roller disposed in each of the plurality of image forming units, so as to collect transfer residual toner remaining on the image carrier after the primary transfer;
a cleaning voltage power supply that applies a voltage to the collecting roller; and
a control unit that controls the image forming unit, the developing voltage power supply, the transfer voltage power supply, the charging voltage power supply, and the cleaning voltage power supply, wherein
the image forming apparatus performs a transfer residual toner collection operation including
a toner adhesion step of applying the collecting roller with a voltage having opposite polarity to charge polarity of the toner during execution of an image forming operation, so as to allow the transfer residual toner to temporarily adhere to the collecting roller,
a toner moving step of separating the developer carrier and the image carrier from each other after finishing the image forming operation, and then applying the collecting roller with a voltage having the same polarity as the charge polarity of the toner, so as to move the transfer residual toner adhered on the collecting roller to the image carrier, and
a toner collecting step of moving the transfer residual toner from the image carrier to the intermediate transfer body, so that the cleaning mechanism collects the transfer residual toner,
the image forming apparatus further comprises a current detection unit that detects developing current flowing between the image carrier and the developer carrier, and
the control unit controls the image forming unit having the developing current less than a threshold value, to apply the collecting roller with the voltage having the same polarity as the charge polarity of the toner in the toner adhesion step, and to apply the collecting roller with the voltage having opposite polarity to the charge polarity of the toner in the toner moving step, so as to perform the transfer residual toner collection operation.

2. The image forming apparatus according to claim 1, wherein the control unit controls the image forming unit having the developing current less than the threshold value, to apply the collecting roller with the voltage having the same polarity as the charge polarity of the toner, in the state where the developer carrier and the image carrier are separated from each other, before first image forming operation after the transfer residual toner collection operation is performed.

3. The image forming apparatus according to claim 1, wherein the control unit controls the image forming unit having the developing current less than the threshold value, to apply the collecting roller alternately with the voltage having the same polarity as the charge polarity of the toner and the voltage having the opposite polarity to the same, in the state where the developer carrier and the image carrier are separated from each other, before first image forming operation after the transfer residual toner collection operation is performed.

4. The image forming apparatus according to claim 1, wherein the control unit increases execution time of the toner moving step in the image forming unit having the developing current less than the threshold value, to be longer than that in the image forming unit having the developing current that is the threshold value or more.

5. The image forming apparatus according to claim 1, wherein the control unit decreases rotation speed of the image carrier that is executing the toner moving step in the image forming unit having the developing current less than the threshold value, to be slower than that in the image forming unit having the developing current that is the threshold value or more.

6. The image forming apparatus according to claim 1, wherein the control unit applies the charging device with the charging voltage, during execution of the toner moving step in the image forming unit having the developing current less than the threshold value.

7. The image forming apparatus according to claim 1, wherein
the plurality of image forming units are arranged in parallel along a moving direction of the intermediate transfer body, and
if there is an image forming unit having the developing current less than the threshold value, the control unit controls not only the said image forming unit but also an image forming unit next to the said image forming unit on the downstream side in the moving direction, to apply the collecting roller with the voltage having the same polarity as the charge polarity of the toner when the toner collecting step is executed, and to apply the collecting roller with the voltage having opposite polarity to the charge polarity of the toner when the toner moving step is executed.
